(19) United States
(12) Patent Application Publication
(10) Pub. No.: US 2007/0234837 A1
(43) Pub. Date: Oct. 11, 2007

(54) Automotive shift lever

(76) Inventor: Ronald Alger Russell, Whitehall, MI (US)

Correspondence Address: PORTER WRIGHT MORRIS & ARTHUR LLP, 41 South High Street, Columbus, OH, 43215-6194, US

(21) Appl. No.: 11/393,460

(22) Filed: Mar. 30, 2006

(51) Int. Cl. B60K 17/04; B60K 20/00

(52) U.S. Cl. 74/473.12; 74/473.24

(57) ABSTRACT

A shifter mechanism includes, a base, a shifter lever pivotable relative to the base along a shift path, and a detent assembly. The detent assembly includes a plurality of grooves defining a plurality of gear positions along the shift path, an electric linear actuator having a pin selectively movable along a linear path between a locking position wherein the pin cooperates with the plurality grooves to lock the shifter lever in one of the plurality of gear positions and an unlocking position wherein the shifter lever is movable along the shift path between the plurality of gear positions, and an electric switch operably coupled to the electric linear actuator to selectively activate the linear actuator. The pin of the linear actuator is extendable along a linear path which is substantially vertical or a along a linear path which is substantially horizontal and laterally-extending.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to a shifter lever mechanism for controlling transmissions of motor vehicles and, more particularly, to an electrically operated detent assembly for holding the shifter lever in a desired gear position against movement to other gear positions.

### BACKGROUND OF THE INVENTION

In a vehicle equipped with an automatic transmission, a shift lever or shifter mechanism is typically pivotable over a series of positions representative of desired transmission gears such as, for example, park (P), reverse (R), neutral (N), drive (D), and low gears (D1, D2). The shifter mechanism is connected to the motor vehicle transmission by a suitable mechanical and/or electronic operating linkage to effect actuation of the transmission to the selected gear when the shift lever is pivoted to the transmission gear's representative position. The shift lever is typically provided with a detent assembly which releasably holds the shifter mechanism in position. The detent assembly typically includes a mechanical actuator which is manually operated to release the detent assembly and permit manual pivoting of the shifter lever mechanism to a new position. A typical mechanical actuator is a knob button which when moved inward, moves a rod to move a pawl attached at a lower end of the rod out of engagement with the detent.

The shifter mechanism also typically includes a lock assembly which prevents movement of the shifter mechanism from the park position unless a brake pedal is depressed or other desired precautions are met to reduce the likelihood of unattended or unintended acceleration or the like. These lock assemblies are typically mechanically or electrically actuated devices which block movement of the detent assembly unless the predetermined conditions are met.

U.S. Pat. No. 5,220,984, the disclosure of which is expressly incorporated herein in its entirety by reference, discloses a shifter mechanism. This shifter mechanism attempts to simplify construction by providing an electrically actuated detent assembly with an electrical circuit which prevents actuation unless predetermined conditions are met such as the brake pedal being depressed. While this shifter mechanism is effective in eliminating the need for a separate lock assembly, the detent assembly may be costly to manufacture and assemble primarily due to the high tolerance parts required. Additionally, this shifter mechanism may not lend itself to use in situations where a relatively small package size is desired. Accordingly, there is a need in the art for an improved shifter mechanism.

### SUMMARY OF THE INVENTION

The present invention provides a shifter mechanism which overcomes at least some of the above-noted problems of the related art. According to the present invention, a shifter mechanism comprises, in combination, a base, a shifter lever pivotable relative to the base along a shift path, and a detent assembly. The detent assembly includes a plurality of grooves defining a plurality of gear positions along the shift path, an electric linear actuator having a pin selectively movable along a linear path between a locking position wherein the pin cooperates with the plurality grooves to lock the shifter lever in one of the plurality of gear positions and an unlocking position wherein the shifter lever is movable along the shift path between the plurality of gear positions, and an electric switch operably coupled to the electric linear actuator to selectively activate the linear actuator. The pin of the linear actuator is extendable along a linear path which is substantially vertical.

According to another aspect of the present invention, a shifter mechanism comprises, in combination, a base, a shifter lever pivotable relative to the base along a shift path, and a detent assembly. The detent assembly includes a plurality of grooves defining a plurality of gear positions along the shift path, an electric linear actuator having a pin selectively movable along a linear path between a locking position wherein the pin cooperates with the plurality grooves to lock the shifter lever in one of the plurality of gear positions and an unlocking position wherein the shifter lever is movable along the shift path between the plurality of gear positions, and an electric switch operably coupled to the electric linear actuator to selectively activate the linear actuator. The pin of the linear actuator is extendable along a linear path which is substantially horizontal and laterally-extending.

According to yet another aspect of the present invention, a shifter mechanism comprises, in combination, a base, a shifter lever pivotable relative to the base along a shift path, and a detent assembly. The detent assembly includes a plurality of grooves defining a plurality of gear positions along the shift path, an electric linear actuator having a pin selectively movable along a linear path between a locking position wherein the pin cooperates with the plurality grooves to lock the shifter lever in one of the plurality of gear positions and an unlocking position wherein the shifter lever is movable along the shift path between the plurality of gear positions, and an electric switch operably coupled to the electric linear actuator to selectively activate the linear actuator. The pin directly engages the plurality of grooves to lock the shift lever in one of the plurality of gear positions.

From the foregoing disclosure and the following more detailed description of various preferred embodiments it will be apparent to those skilled in the art that the present invention provides a significant advance in the technology and art of motor vehicle shifter mechanisms. Particularly significant in this regard is the potential the invention affords for providing a high quality, reliable, low cost assembly which utilizes a relatively small number of components and a relatively small amount of center console space. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a perspective view of a shifter mechanism according to a first embodiment of the present invention;

FIG. 2 is another perspective view of the shifter mechanism according of FIG. 1;

FIG. 3 is an enlarged, fragmented perspective view the shifter mechanism of FIGS. 1 and 2, wherein some components are removed for clarity;

FIG. 4 is a perspective view of a shift lever knob or handle of the shifter mechanism of FIGS. 1 to 3;

FIG. 5 is another perspective view of the shift lever knob or handle of FIG. 4, wherein some components are removed for clarity;

FIG. 6 is a perspective view of a shifter mechanism according to a second embodiment of the present invention;

FIG. 7 is another perspective view of the shifter mechanism according of FIG. 6;

FIG. 8 is an enlarged, fragmented perspective view the shifter mechanism of FIGS. 6 and 7, wherein some components are removed for clarity; and

FIG. 9 is a perspective view of a shift lever knob or handle of the shifter mechanism of FIGS. 6 to 8, wherein some components are removed for clarity.

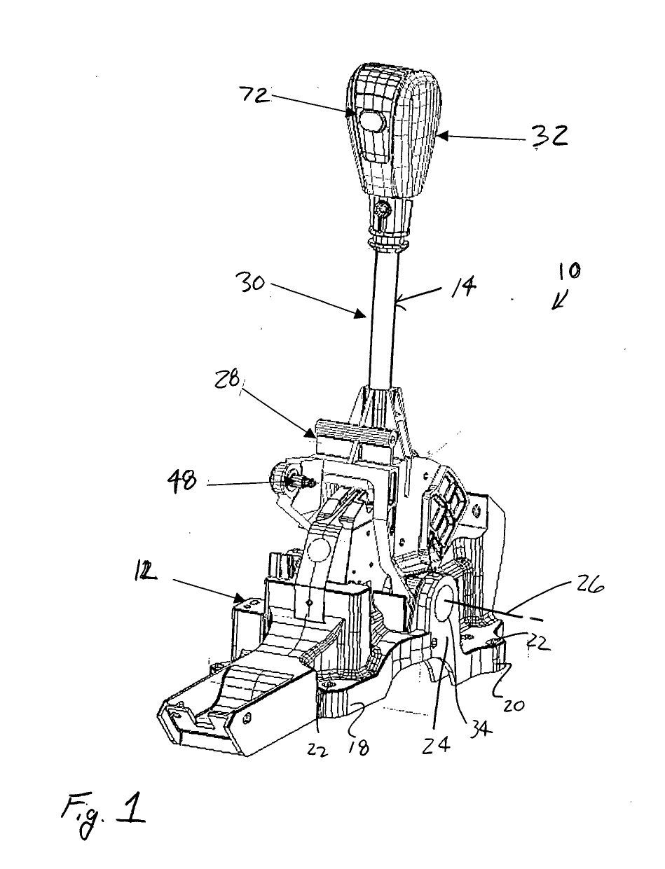

It should be understood that the appended drawings are not necessarily to scale, presenting a somewhat simplified representation of various preferred features illustrative of the basic principles of the invention. The specific design features of a shifter mechanism as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the shifter lever mechanism illustrated in the drawings. In general, up or upward generally refers to an upward direction within the plane of the paper in FIG. 1 and down or downward generally refers to a downward direction within the plane of the paper in FIG. 1. Also in general, fore or forward refers to a direction toward the front of the vehicle, that is, generally toward the left within the plane of the paper in FIG. 1 and aft or rearward refers to a direction toward the rear of the vehicle, that is, generally toward the right within the plane of the paper in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved shifter mechanisms disclosed herein. The following detailed discussion of various alternative and preferred embodiments will illustrate the general principles of the invention with reference to shifter mechanisms for motor vehicles such as an automobile, sport utility vehicle (SUV), or truck. Other embodiments suitable for other applications will be apparent to those skilled in the art given the benefit of this disclosure.

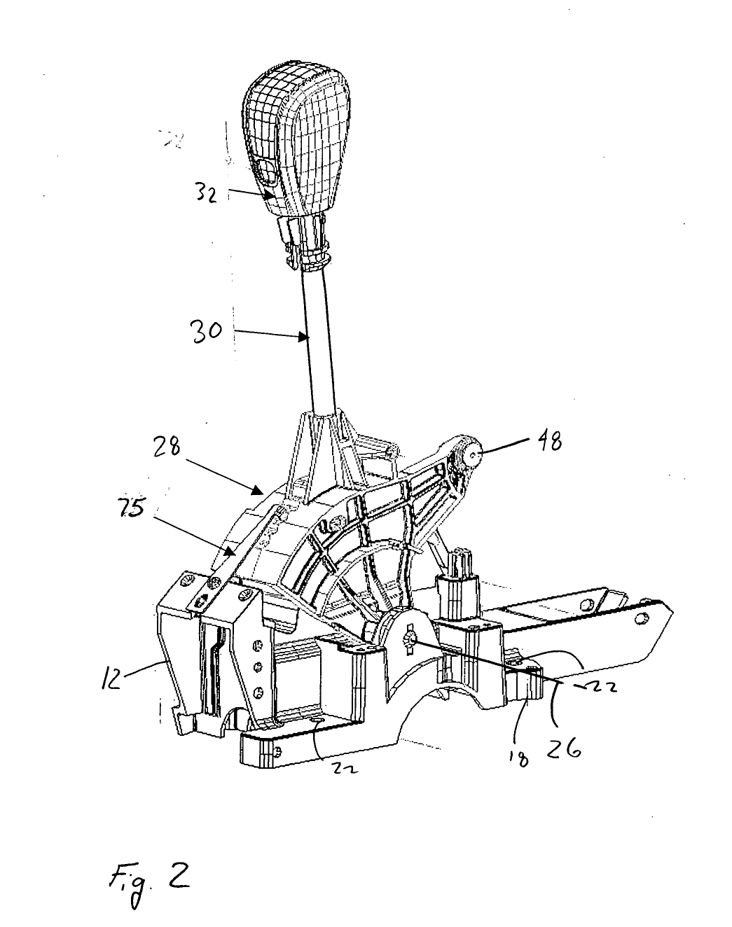

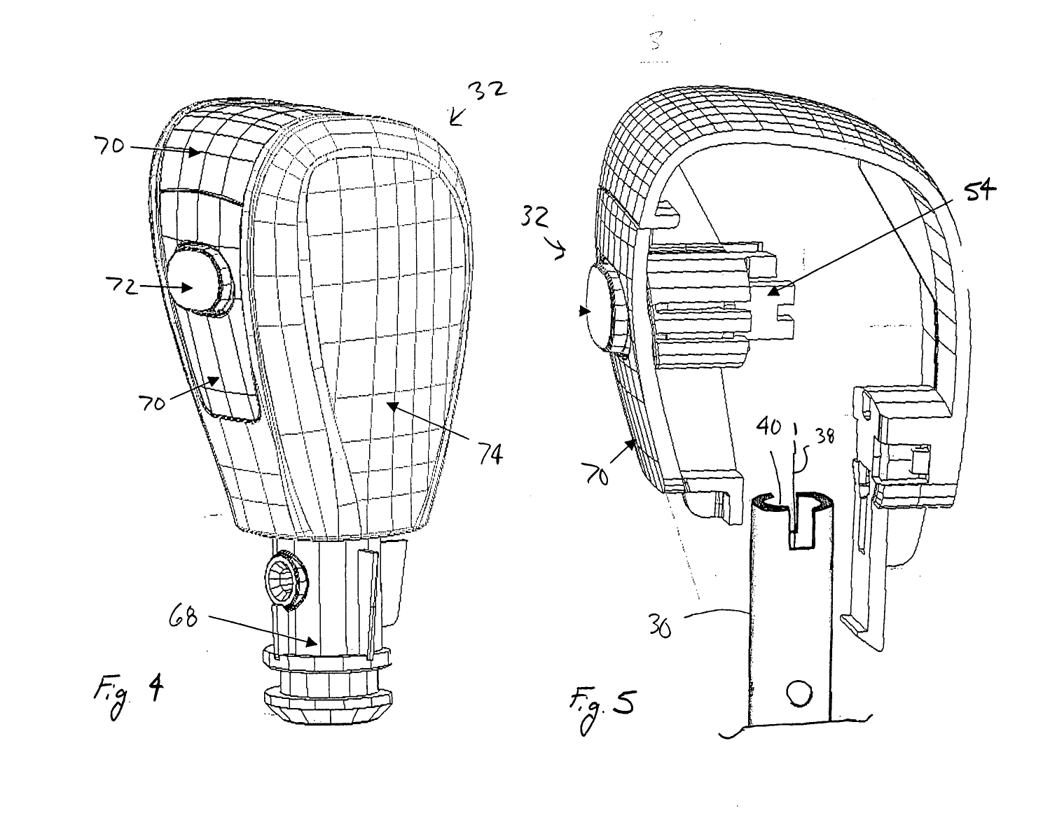

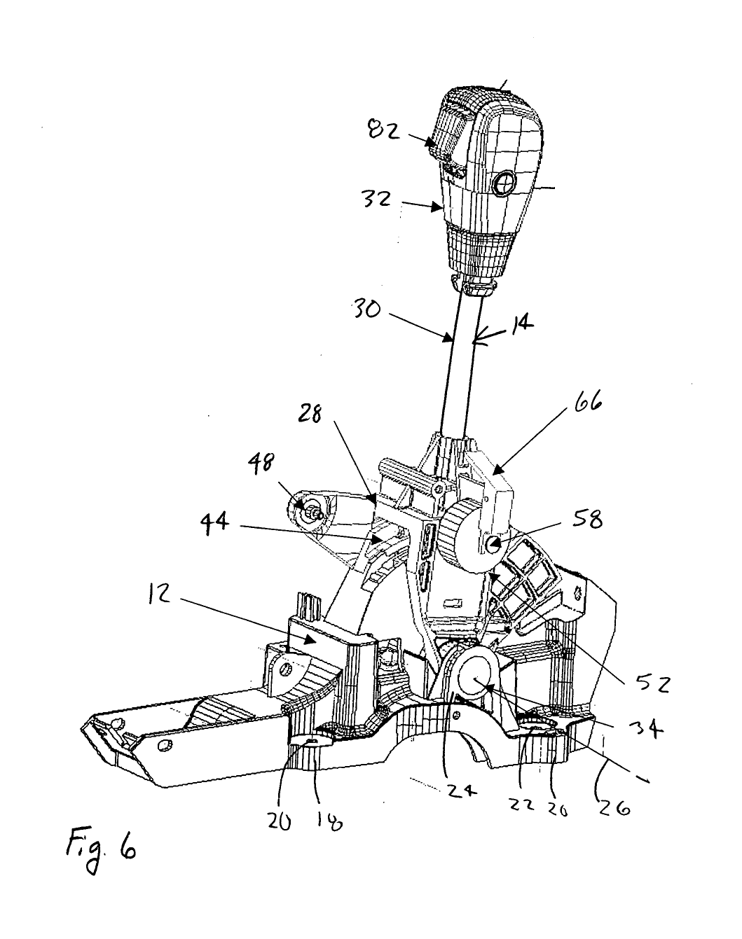

Referring now to the drawings, FIGS. 1 to 5 show a shift lever or shifter mechanism 10 according to a preferred embodiment of the present invention. The illustrated shifter mechanism 10 includes a frame or base 12, a shift lever assembly 14 pivotably mounted to the base 12, and a lock or detent assembly 16 releasably holding the shift lever assembly 14 in a desired one of a plurality of gear positions against undesired movement to the other gear positions.

The base 12 is adapted to be attached to the motor vehicle in a fixed position such as a floor or console. The base 12 is preferably shaped to engage the motor vehicle in a desired manner. The illustrated base 12 has flanges or ears 18, 20 that are provided with openings or holes 22 for receiving mechanical fasteners such as bolts to secure the base to the motor vehicle. Other suitable attachment means or systems will be apparent to those skilled in the art. A pair of upwardly extending pivot flanges 24 is provided along a central portion of the base 12 at lateral sides of the base 12. The pivot flanges 24 are laterally spaced apart and provided with concentric openings for pivotably mounting the shifter lever assembly 14 therebetween as described in more detail hereinafter. The flange openings define a horizontal and laterally extending pivot axis 26 for the shifter lever assembly 14.

The illustrated shifter lever assembly 14 includes a pivot member or yoke 28, a shift post or lever 30 for manually moving the pivot member 28, and knob or handle 32 at an upper or free end of the shift lever 30. The lower end of the pivot member 30 is sized and shaped to extend between the pivot flanges 24 of the base 12 and is provided with horizontal, laterally extending, opposed pivot pins 34 which cooperate with the flange openings to provide a pivotable connection between the pivot member 28 and the base 12. Pivotably connected in this manner, the pivot member 28 is pivotable relative to the base 12 about the horizontal and laterally extending pivot axis 26. The upper end of the pivot member 28 is provided with an opening 36 for securing the shift lever 30 to the pivot member 28.

The illustrated shift lever 30 is generally an elongate straight tube having a central axis 38 and forming a hollow central passage 40 extending along the central axis 28. The lower end of the shift lever 30 is adapted to extend into the opening 36 in the pivot member 28 and is provided with opposed flanges side flanges 42 which cooperate with the opening 36 to limit rotational movement of the shift lever 30 within the opening 36 about the central axis 38. preferably, a snap-fit connection is provided that rigidly secures the shift lever 30 to the pivot member 28 without the use of mechanical fasteners. It is noted that the shift lever 30 can alternatively be secured to the pivot member 28 in other suitable manners such as, for example, welding, adhesives, or mechanical fasteners or the shift lever 30 can be formed unitary, that is, as one piece, with the pivot member 28. With the shift lever 30 secured to the pivot member 28, the pivot member 28 can be pivoted about the pivot axis 26 by manually applying a force to the shift lever 30. The upper end of the illustrated shift lever 30 is preferably provided with the handle or knob 32. The knob 32 is preferably provided with a shape to provide a suitable gripping surface for the hand of the operator and is preferably constructed as described in more detail hereinafter.

The illustrated pivot member 28 is provided with a detent flange or plate 44 that pivots with the pivot member 28 about the pivot axis 26. The illustrated detent plate 44 is arc-shaped having a center of curvature generally at the pivot axis 26. The illustrated detent plate 44 and has a lower contoured surface with a plurality of downward facing grooves or notches 46 formed therein. The grooves 46 correspond with various gear positions in which the shift lever assembly 14 can be moved to provide a desired gear at the transmission of the motor vehicle. The grooves 46 can indicate positions such as park (P), reverse (R), neutral (N), drive (D), first gear (1), and second gear (2). The shifter lever assembly 14 is suitably connected to the transmission of the motor vehicle such that movement the shift lever 30 to the various positions causes the transmission to move to the corresponding gear. The illustrated pivot member 28 is provided with a cable attachment 48 so that the end of a cable can be secured thereto which actuates the transmission upon movement of the shift lever 30 and the pivot member 28. The grooves 46 pivot about the pivot axis 26 with the detent plate 44 when the shift lever 30 is pivoted and are sized and shaped to cooperate with the detent assembly 16 to limit movement as discussed in more detail hereinbelow. The grooves 46 are each similarly sized and shaped as desired. The illustrated grooves 46 are formed such that some rotations are blocked and other are restricted to one direction only depending on whether perpendicular or angled abutments are formed.

The illustrated lock or detent assembly 16 includes a pawl 50 movable into and out of engagement with the grooves 46, an electric linear actuator 52 for selectively moving the pawl 50 into and out of engagement with the grooves 46, and an electric switch 54 for selectively activating actuator 52. The illustrated actuator 52 of detent assembly 16 is secured to the base 12 within a vertically extending opening centrally located in the base 12 below the pivoting member 28 so that the pawl 50 is selectively moved along a vertical linear path extending toward and away from the grooves 46, that is, in a direction substantially perpendicular to the groove 46 located directly above the actuator 52.

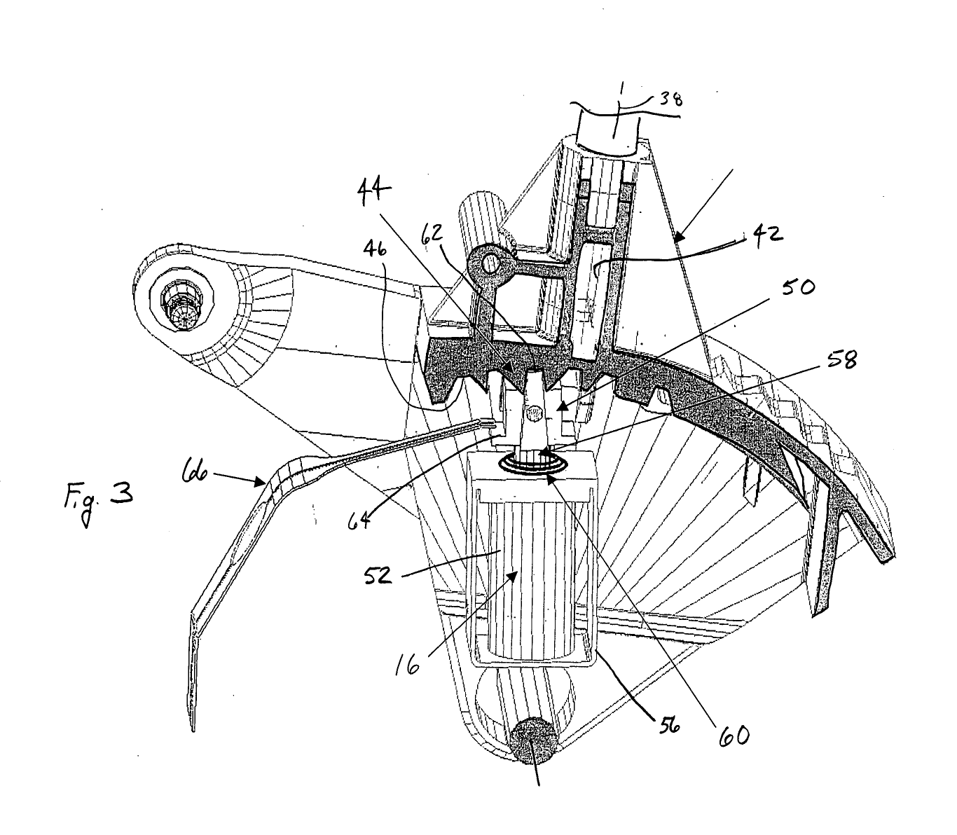

The illustrated electric linear actuator 52 is in the form of a solenoid but any other suitable actuator can be utilized within the scope of the present invention. The illustrated solenoid 52 includes a body or housing 56 and an extendable pin or shaft 58. The pin 58 has a central axis 60 and is typically in an extended position (best shown in FIG. 3) but linearly moves along the central axis 60 to a retracted position when the solenoid 52 is activated. The pawl 50 is rigidly secured to the pin 58 for linear movement therewith. The solenoid 52 is secured to the base 12 with the pin 58 extending through an opening in a top wall of the base 12 to engage the grooves 46. When the solenoid 52 is unactivated, a return spring resiliently moves the pin 58 to its extended position so that the pawl 50 is in its locking position engaging the grooves 46. Thus the spring 60 biases the pawl 50 into the locking position. The spring or spring member 60 is preferably sized such that it provides a suitable force to maintain the pawl 50 in the locking position but is resiliently overcome by the actuator 52 when it is desired to move the pawl 50 into the unlocking position. The illustrated spring 60 is a coil spring located at the pin 60 which acts between housing 56 and the pin 58. It is noted that other suitable types of springs and other suitable locations of the spring 60 can be used within the scope of the present invention. When the solenoid 52 is activated, the pin 58 linearly moves downward from the retracted position to the extended position to move the pawl 50 downward from its locking position to its unlocking position wherein the pawl 50 is disengaged from the grooves 46 so that the pivot member 28 is free to move.

The illustrated pawl 50 is generally rectangular having a vertically-extending tooth or engagement member 62 at an upper side thereof. The pawl 50 is sized and shaped to closely cooperate with the guide opening in the base 12 so that the guide opening guides the pawl to maintain movement of the pawl 50 along the linear path. The engagement member 62 of the pawl 50 is sized and shape to cooperate with the grooves 46 of the detent plate 44 so that the pawl 50 blocks and limits pivotal movement of the shifter lever assembly 14 when the engagement member 62 is in one of the grooves 46 but permits pivotal movement of the shifter lever assembly 14 when the engagement member 62 of the pawl 50 is removed from the grooves 46. A lower end of the pawl 50 is sized and shaped to be attached to the pin 58. Preferably the pawl 50 is pinned to the pin 58 to allow limited pivoting motion therebetween to automatically account for slight misalignment between the actuator pin 58 and the grooves 46. The lower end of the illustrated pawl 50 is also provided with a flange 64 forming an upward facing abutment for engagement by a manually-operable override member 66.

The override member 66 enables the pawl 50 to be manually moved from the locking position to the unlocking position without activating the actuator 52 so that the pawl 50 can be moved when the actuator 52 can not be activated such as, for example, upon power failure. The illustrated override member 66 is a unitary, resiliently deflectable member having a first or fixed end secured to the base 12 and a second or free end cantilevered from the base 12. The free of the override member 66 extends over the flange 64 of the pawl 50 when in its free or undeformed state. To actuate the pawl 50, the operator pushes downward on the override member 66 so that it resiliently deforms to move the free end downward to engage the pawl flange 64 and move the pawl 50 in a downward direction to its unlocked position. The operator can then pivot the shift lever 30 to change gears as desired. When the override member 66 is released by the operator, the override member 66 resiliently snaps back to its free state and the return spring 60 returns the pawl 50 to its locking position. It is noted that any other suitable manually-operable override mechanism or device can alternatively be utilized.

The electric switch 54 for activating the electric linear actuator 52 is preferably provided the knob 32 located at the top of the shift lever 30. A push button 72 of the illustrated switch 54 is located at the forward side of the knob 32 but any other suitable location can alternatively be utilized. The shifter lever switch 54 is preferably a momentary contact switch such as, for example, a push button switch or a dome switch but can alternatively be any other suitable type of electric switch. Wires connecting the switch 54 to the remainder of the circuit preferably extend through the hollow interior passage 40 of the shift lever 30 and a hollow interior passage extending through the pivot member 28.

The illustrated knob 32 includes a knob substrate 68 sized and arranged for connection to the top of the shift lever 30 and a trim plate 70. The electric switch 54 is secured to the trim plate 70 and has an actuatable push button 72 that extends to an exterior side of the trim plate 70. A knob cover 74 fully encloses the knob 32. It is noted that the knob 32 can alternatively have any other suitable construction.

A control circuit for operation of the actuator 52 connects the coil of the solenoid 52 with the switch 54 and with power sources such as, for example, the battery system and ignition/alternator system of the motor vehicle. The control circuit can be of any suitable configuration such as, for example, the control circuit disclosed in U.S. patent application Ser. No. 10/413,764, the disclosure of which is expressly disclosed herein in its entirety by reference.

The illustrated shifter mechanism 10 also includes an artificial feel-spring 75 to provide the operator on positioning. The illustrated artificial feel spring is a unitary, resiliently deflectable member having a first or fixed end secured to the base 12 and a second or free end cantilevered from the base 12. The free of the spring engages a plurality of grooves formed in an upper surface of the pivot member 28 which are representative of the detent grooves 46. As the pivot member 28 pivots about its pivot axis 26, the free end of the spring resiliently travels along the grooves to prove feed back to the operator. It is noted that any other suitable artificial-fee spring or device can alternatively be utilized.

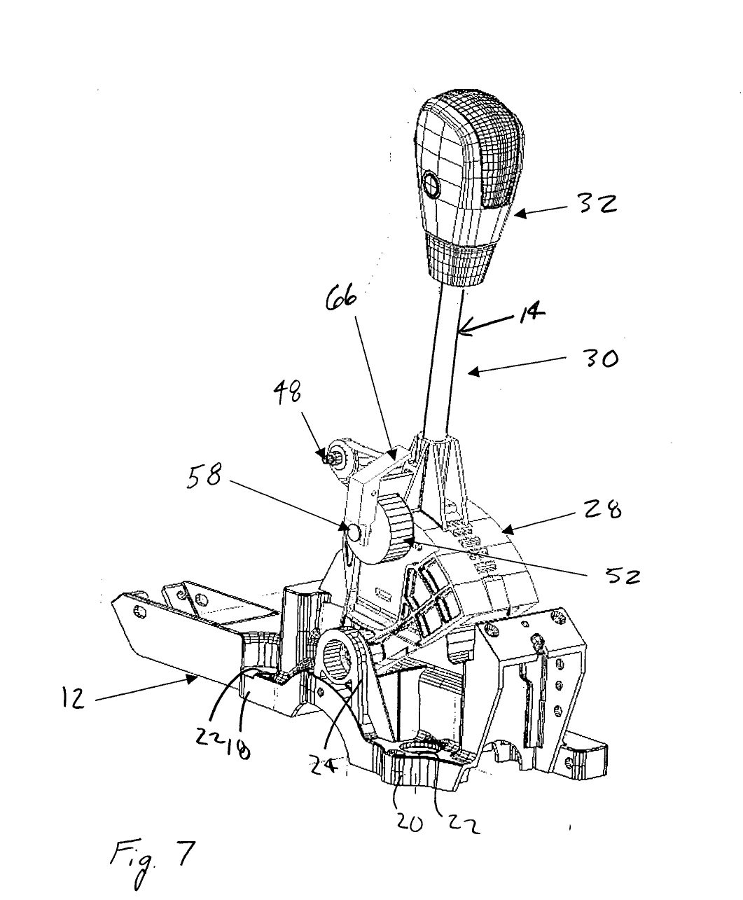

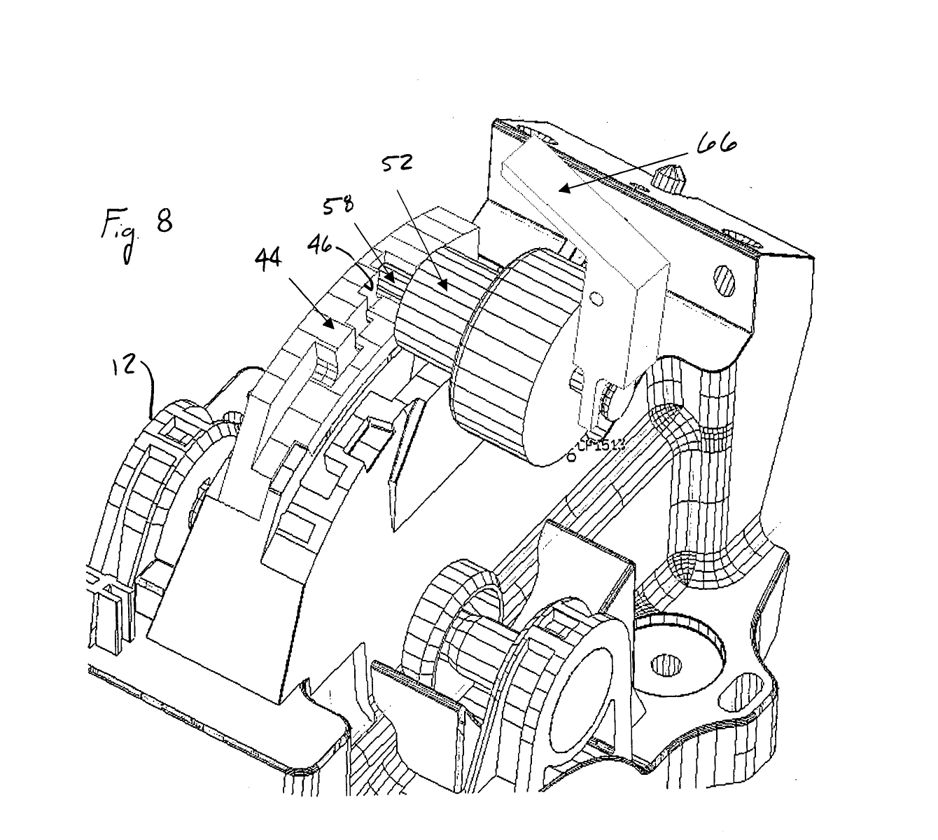

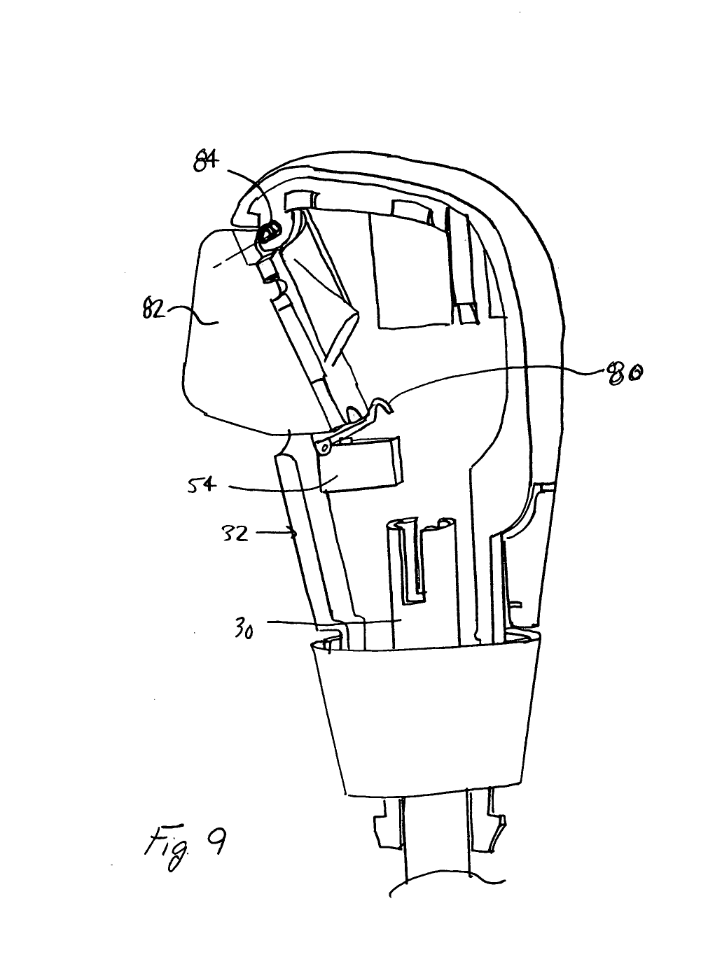

FIGS. 6 to 9 show a shift lever or shifter mechanism 100 according to a second preferred embodiment of the present invention. The shifter mechanism 100 according to the second embodiment is substantially similar to the shifter mechanism 10 according to the first embodiment and like reference numbers are utilized to indicate like structure. The shifter mechanism according to the second embodiment illustrates that the actuator can act in a horizontal, lateral direction and/or that the actuator can be carried by the pivot member 28.

The illustrated base 12 is provided with the detent flange or plate 44 that remains stationary relative to the pivot member 28 as the pivot member 28 pivots about the pivot axis 26. The illustrated detent plate 44 is arc-shaped having a center of curvature generally at the pivot axis 26. The illustrated detent plate 44 and has a laterally inward-facing contoured surface with a plurality of laterally facing grooves or notches 46 formed therein. The grooves 46 correspond with various gear positions in which the shift lever assembly 14 can be moved to provide a desired gear at the transmission of the motor vehicle. The grooves 46 can indicate positions such as park (P), reverse (R), neutral (N), drive (D), first gear (1), and second gear (2). The shifter lever assembly 14 is suitably connected to the transmission of the motor vehicle such that movement the shift lever 30 to the various positions causes the transmission to move to the corresponding gear. The illustrated pivot member 28 is provided with a cable attachment 48 so that the end of a cable can be secured thereto which actuates the transmission upon movement of the shift lever 30 and the pivot member 28. The grooves 46 remain stationary when the shift lever 30 is pivoted and are sized and shaped to cooperate with the detent assembly 16 to limit movement as discussed in more detail hereinbelow. The grooves 46 are each similarly sized and shaped as desired. The illustrated grooves 46 are formed such that some rotations are blocked and other are restricted to one direction only depending on whether perpendicular or angled abutments are formed.

The illustrated lock or detent assembly 16 includes the electric linear actuator 52 which moves the pin 58 into and out of engagement with the grooves 46 and the electric switch 54 for selectively activating actuator 52. The illustrated actuator 52 of detent assembly 16 is secured to the pivot member 28 within a horizontal and laterally extending opening spaced apart from the pivot axis 26 so that the pin is selectively moved along a arc-shaped path when the pivot member is rotated about the pivot axis 26 and extends toward and away from the grooves 46, that is, in a direction substantially perpendicular to the groove 46 located laterally beside the actuator 52 along a horizontal and laterally extending path when the actuator 52 is activated and deactivated.

The illustrated pin 58 directly engages the grooves 46, that is, no pawl is secured to the end of the pin 58. Alternatively, a suitable pawl can be secured to the end of the pin 58 for motion therewith and engaging the grooves 46, When the solenoid 52 is unactivated, the return spring 60 resiliently moves the pin 58 to its extended position so that it is in its locking position engaging the grooves 46. Thus the spring 60 biases the pin 58 into the locking position. When the solenoid 52 is activated, the pin 58 linearly moves horizontally and laterally from the retracted position to the extended position and from its locking position to its unlocking position wherein the pin 58 is disengaged from the grooves 46 so that the pivot member 28 is free to move. The outer end of the illustrated pin 58 is also provided with a flange 76 forming a laterally inward facing abutment for engagement by a manually-operable override member 66.

The illustrated override member 66 is a rigid lever pivotably secured to a flange 78 of the pivot member 28. A first end of the override member 66 has a slot that receives the pin 58 therein adjacent the pin flange 76. A second end of the override member 66 extends upwardly and inwardly to form a handle arm. To actuate the pin 58, the operator pushes downward on the second end of the override member 66 so that it pivots about its pivot axis 80 to move the second end laterally outward to engage the pin flange 76 and move the pin 58 in a laterally outward direction to its unlocked position. The operator can then pivot the shift lever 30 to change gears as desired. When the override member 66 is released by the operator, the return spring 60 returns the pawl 50 to its locking position and the override member 66 is moved therewith. It is noted that any other suitable manually-operable override mechanism or device can alternatively be utilized.

The illustrated shift lever switch 54 has a button 82 that pivots about a pivot pin 86 but can alternatively be any other suitable type of electric switch. The illustrated button when pivoted, engages a pivoting switch arm 88 of the switch 54 to activate the actuator 52. Wires connecting the switch 54 to the remainder of the circuit preferably extend through the hollow interior passage 40 of the shift lever 30 and a hollow interior passage extending through the pivot member 28.

It is apparent from the foregoing disclosure and detailed description that the shifter mechanism according to the present invention eliminates components of prior devices, improves on build tolerances stack conditions and is easier to assemble than prior mechanisms. The illustrated shifter mechanisms also eliminate the need for a brake transmission shift interlock (BTSI). The illustrated shifter mechanisms further provides a very high quality feel to the operator by eliminating button and actuator rod friction and eliminates rattle of the actuator rod. Moreover, the shifter mechanism utilize a relatively small package space.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A shifter mechanism comprising, in combination:
a base;
a shifter lever pivotable relative to the base along a shift path;
a detent assembly including a plurality of grooves defining a plurality of gear positions along the shift path, an electric linear actuator having a pin selectively movable along a linear path between a locking position wherein the pin cooperates with the plurality grooves to lock the shifter lever in one of the plurality of gear positions and an unlocking position wherein the shifter lever is movable along the shift path between the plurality of gear positions, and an electric switch operably coupled to the electric linear actuator to selectively activate the linear actuator; and
wherein the pin of the linear actuator is extendable along a linear path which is substantially vertical.

2. The shifter system according to claim 1, wherein said plurality of grooves is carried with the shifter lever as the shifter lever moves along the shift path and the electric linear actuator is secured to the base.

3. The shifter system according to claim 1, wherein said linear actuator is a solenoid.

4. The shifter system according to claim 3, wherein said pin is in an extended position when said solenoid is unenergized and a retracted position when said solenoid is energized.

5. The shifter system according to claim 1, wherein said pin is in an extended position when in the unlocking position and a retracted position when in the locking position.

6. The shifter system according to claim 1, wherein the actuator is located below the plurality of grooves.

7. The shifter system according to claim 1, further comprising a manually-operable override member that is resiliently deflectable to move the pin from the locking position to the unlocking position.

8. A shifter mechanism comprising, in combination:
a base;
a shifter lever pivotable relative to the base along a shift path;
a detent assembly including a plurality of grooves defining a plurality of gear positions along the shift path, an electric linear actuator having a pin selectively movable along a linear path between a locking position wherein the pin cooperates with the plurality grooves to lock the shifter lever in one of the plurality of gear positions and an unlocking position wherein the shifter lever is movable along the shift path between the plurality of gear positions, and an electric switch operably coupled to the electric linear actuator to selectively activate the linear actuator; and
wherein the pin of the linear actuator is extendable along a linear path which is substantially horizontal and laterally-extending.

9. The shifter system according to claim 8, wherein said electric linear actuator is carried with the shifter lever as the shifter lever moves along the shift path and the plurality of grooves is stationary with the base.

10. The shifter system according to claim 8, wherein said linear actuator is a solenoid.

11. The shifter system according to claim 10, wherein said pin is in an extended position when said solenoid is unenergized and a retracted position when said solenoid is energized.

12. The shifter system according to claim 8, wherein said pin is in an extended position when in the unlocking position and a retracted position when in the locking position.

13. The shifter system according to claim 8, wherein the actuator is located laterally adjacent the plurality of grooves.

14. The shifter system according to claim 8, further comprising a manually-operable override member that is pivotable to move the pin from the locking position to the unlocking position.

15. A shifter mechanism comprising, in combination:
a base;
a shifter lever pivotable relative to the base along a shift path;
a detent assembly including a plurality of grooves defining a plurality of gear positions along the shift path, an electric linear actuator having a pin selectively movable along a linear path between a locking position wherein the pin cooperates with the plurality grooves to lock the shifter lever in one of the plurality of gear positions and an unlocking position wherein the shifter lever is movable along the shift path between the plurality of gear positions, and an electric switch operably coupled to the electric linear actuator to selectively activate the linear actuator; and
wherein the pin directly engages the plurality of grooves to lock the shift lever in one of the plurality of gear positions.

16. The shifter system according to claim 15, wherein said electric linear actuator is carried with the shifter lever as the shifter lever moves along the shift path and the plurality of grooves is stationary with the base.

17. The shifter system according to claim 15, wherein said linear actuator is a solenoid.

18. The shifter system according to claim 17, wherein said pin is in an extended position when said solenoid is unenergized and a retracted position when said solenoid is energized.

19. The shifter system according to claim 15, wherein said pin is in an extended position when in the unlocking position and a retracted position when in the locking position.

20. The shifter system according to claim 15, wherein the pin of the linear actuator is extendable along a linear path which is substantially horizontal and laterally-extending path.
